(19) United States
(12) Patent Application Publication
(10) Pub. No.: US 2011/0083805 A1
(43) Pub. Date: Apr. 14, 2011

(54) ADHESIVES

(75) Inventors: Paul Birnbrich, Solingen (DE); Hans-Josef Thomas, Korschenbroich (DE)

(73) Assignee: COGNIS IP MANAGEMENT GMBH, Dusseldorf (DE)

(21) Appl. No.: 12/894,302

(22) Filed: Sep. 30, 2010

(30) Foreign Application Priority Data
Oct. 8, 2009 (EP) 09012736.6

(51) Int. Cl. B32B 37/12; B32B 27/42

(52) U.S. Cl. 156/335

(57) ABSTRACT

Compositions obtained by reacting the cardanol-containing raw material cashew nut shell liquid (CNSL) with (a) ammonia, or an amine which comprises at least one primary or at least two secondary amino groups, and (b) formaldehyde, are disclosed as adhesives.

### CROSS-REFERENCE TO RELATED APPLICATIONS

The present application claims priority under 35 USC §119 to European Patent Application number 09012736.6, filed Oct. 8, 2009, which is incorporated herein in its entirety.

### FIELD OF THE INVENTION

The invention relates to the use of compositions obtained by reacting the cardanol-containing raw material cashew nut shell liquid (CNSL) with (a) ammonia or an amine which comprises at least one primary or at least two secondary amino groups, and (b) formaldehyde, as adhesives.

### BACKGROUND OF THE INVENTION

Phenalkamines are a still relatively young class of epoxy resin hardeners. They constitute reaction products (condensation products) of cardanol (I), which in chemical terms is a C₁₅-alkylphenol and is a major constituent of the oil obtained from the shells of cashew nuts (i.e., of CNSL—cashew nut shell liquid), with aliphatic primary or secondary amines and formaldehyde.

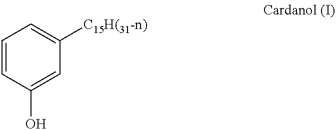

It should be expressly emphasized that the phenalkamines as such are not used for adhesive purposes, but merely as epoxy resin hardeners.

E. Calo et al. in Green Chemistry, 2007, 9, pp. 754-759 describe a process in which they convert cardanol into a specific benzoxazine monomer. The synthesis of this specific benzoxazine (abbreviated in the article as “Bz”) is described at page 756, left-hand column, second paragraph. This compound Bz is used subsequently to investigate different polymerization reactions.

DE-A-102007057951 describes the use of compositions obtained by reacting the cardanol-containing raw material CNSL with (a) ammonia or an amine which comprises at least one primary amino group (NH₂ group) and (b) formaldehyde, for the coating of surfaces of solid substrates. Nothing is disclosed regarding the possible use of these compositions as adhesives.

### SUMMARY OF THE INVENTION

One object of the present invention was to provide compositions suitable for use as adhesives.

The subject matter of the invention is the use of the compositions obtained by reacting the cardanol-containing raw material CNSL (cashew nut shell liquid) with (a) ammonia, or an amine which comprises at least one primary or at least two secondary amino groups, and (b) formaldehyde, as adhesives.

### DETAILED DESCRIPTION OF PREFERRED EMBODIMENTS

The composition for use in accordance with the invention may be prepared by reaction of the cardanol-containing raw material CNSL (cashew nut shell liquid) with (a) ammonia, or an amine which comprises at least one primary or at least two secondary amino groups, and (b) formaldehyde, in a reaction known as the Mannich reaction. The Mannich reaction is an aminoalkylation of organic compounds which are CH-acidic in the alpha position of a functional group. CH-acidic compounds of this kind are reacted with formaldehyde and ammonia and/or with a primary or secondary amine. Using CNSL as the CH-acidic compound results in mixtures (compositions) comprising various benzoxazines and aminoalkylation products of cardanol.

It should be noted that the use of the compositions of the invention as adhesives is not disclosed in the above-cited article by E. Calo et al. The article describes polymerization reactions of a single monomer (Bz), whereas the present invention is centered on using a mixture (composition) which comprises various benzoxazines and also aminoalkylation products of cardanol, and using it for a very specific purpose, namely as adhesives. The situation is similar with the above-cited specification DE-A-102007057951. There as well, the use as adhesives of the compositions identified in that specification, is neither disclosed nor suggested.

### CNSL

The CNSL used in the course of the present invention is of natural origin—it is extracted from the outer shells of cashew nuts (nuts from the tree Anacardium occidentale) and can vary in its composition. Typically it contains 60-65% cardanol, 2-10% cardol, 10-15% oligomers/polymers, and 0-2% 2-methylcardanol and anacardic acid.

In one embodiment, crude CNSL is used.

In one embodiment, purified CNSL is used. The purification may include, inter alia, pretreatment and/or distillation. It may be desired to subject CNSL to a pretreatment in order to remove impurities. Pretreatment and distillation of CNSL may also be combined, particularly when it is desired to use a color-stable CNSL with particularly high cardanol content. Particularly preferred pretreatments are chemical pretreatments, more preferably the pretreatments with boric acid and with acetic anhydride, as are described in WO 2006/108545 A1 and in WO 2006/108546 A1, both of which are included herein by reference. One embodiment of the present invention uses CNSL in a quality of the kind obtained by one of the processes of WO 2006/108545 A1 and WO 2006/108546 A1.

### Amine Component (a)

Component (a) comprises ammonia, or an amine which comprises at least one primary or at least two secondary amino groups. As is commonly understood in the art, primary amino groups are NH₂ groups and secondary amino groups are NH groups, i.e., the nitrogen atom of a primary amino group has two hydrogen atoms, and the nitrogen atom of a secondary amino group has one hydrogen atom.

In one embodiment of the invention, component (a) comprises ammonia.

A further embodiment uses an amine which comprises at least one primary amino group as component (a).

A further embodiment uses as component (a) an amine selected from the group of polyamines, these polyamines being subject to the proviso that they must comprise at least two amino groups which are primary or secondary amino groups. In this embodiment, therefore, for each molecule of polyamine there must be either at least two primary amino groups, or at least two secondary amino groups, or at least one primary and at least one secondary amino group. Where the polyamines comprise further amino groups, in addition to the two mandatory primary and/or secondary amino groups, these further amino groups may be primary, secondary or tertiary. The polyamines may be aliphatic, aromatic, aliphatic-aromatic, cycloaliphatic, or heterocyclic.

Examples of suitable amines are as follows: alkylamines having linear or branched alkyl chains such as n-butylamine, tert-butylamine, n-pentylamine, n-hexylamine, 2-ethylhexylamine, n-octylamine; aromatic amines such as aniline, toluidine; alkylaromatic amines such as benzylamine; polyethyleneamines (ethylenediamine, diethylenetriamine, triethylenetetramine, tetraethylenepentamine, etc.), 1,2-propylenediamine, 1,3-propylenediamine, 1,4-butanediamine, 1,5-pentanediamine, 1,3-pentanediamine, 1,6-hexanediamine, 3,3,5-trimethyl-1,6-hexanediamine, 3,5,5-trimethyl-1,6-hexanediamine, 2-methyl-1,5-pentanediamine, bis(3-aminopropyl)amine, N,N′-bis(3-aminopropyl)-1,2-ethanediamine, N-(3-aminopropyl)-1,2-ethanediamine, 1,2-diaminocyclohexane, 1,3-diaminocyclohexane, 1,4-diaminocyclohexane, aminoethylpiperazines, poly(alkylene oxide)diamines, and triamines (such as, for example, JEFFAMINE® D-230, JEFFAMINE® D-400, JEFFAMINE® D-2000, JEFFAMINE® D-4000, JEFFAMINE® T-403, JEFFAMINE® EDR-148, JEFFAMINE® EDR-192, JEFFAMINE® C-346, JEFFAMINE® ED-600, JEFFAMINE® ED-900, JEFFAMINE® ED-2001), meta-xylylenediamine, phenylenediamine, 4,4′-diaminodiphenylmethane, toluenediamine, isophoronediamine, 3,3′-dimethyl-4,4′-diaminodicyclohexylmethane, 4,4′-diaminodicyclohexylmethane, 2,4′-diaminodicyclohexylmethane, 1,3-bis(aminomethyl)cyclohexane, the mixture of poly(cyclohexyl-aromatic)amines linked by a methylene bridge (also known as MBPCAA), and polyaminoamides.

One preferred embodiment uses as component (a) a monofunctional primary amine of the formula R—NH₂ (I) where the R-group is an alkyl group having a total of 1 to 30 C atoms or an aryl group or an aryl group which is further substituted by one or more alkyl groups and has a total of up to 30 C atoms.

### Preparation and Use of the Compositions

The Mannich reaction of cardanol with formaldehyde and amines produces mixtures of benzoxazines and also higher molecular mass products and unreacted cardanol. These mixtures are suitable without further purification for use as adhesives.

The compositions of the invention are applied directly to the surfaces of the substrates to be bonded to one another, it being sufficient in many cases to apply the compositions of the invention only to the surface of one of the substrates to be bonded to one another. The manner of their application is not critical per se. Examples of suitable methods of application include the following, for instance: doctor-coating, spreading, rolling, drawing (knife), wiping, pouring, dripping, spraying.

The substrates to be bonded to one another are subsequently contacted with one another, the adhesive being located between the two substrates.

In one embodiment the compositions to be used as adhesives in accordance with the invention are applied in hot form; in other words, the compositions are heated to temperatures in the range from 50° C. to 200° C. and more particularly 100° C. to 150° C. and are applied as hot adhesives to the substrates to be joined to one another, which are subsequently contacted with one another.

After a curing time, the substrates now bonded to one another can also be subjected to mechanical load. The curing time is dependent essentially on the temperature and on the thickness of the layer of adhesive. Curing is carried out generally at temperatures between 100° C. and 300° C. and more particularly 200° C. and 250° C. Depending on the thickness of the layer of adhesive and on the curing temperature, the curing times are situated within the range from a few seconds through several hours.

The substrates to be bonded to one another are selected more particularly from the group consisting of metals, mineral materials (such as stone, concrete, ceramic), plastics, glass, wood, fibers; particularly preferred in this context are metals, more particularly iron, steel, copper, aluminum, tinplate, nickel, and gold.

In one embodiment, substrates are bonded to one another that are composed of the same material. In another embodiment, substrates are bonded to one another that are composed of different materials.

### EXAMPLES

### Example 1

### Inventive Composition

272.9 g of cardanol were heated together with 30.7 g of 25% ammonia solution, and 116.2 g of 35% aqueous formaldehyde solution in a 1-liter three-neck flask equipped with stirrer, thermometer, and reflux condenser under nitrogen blanketing for 3 hours at 75-80° C. While still hot, the reaction mixture was transferred to a separatory funnel. The aqueous phase quickly settled and was drained off. The oil phase was washed with 100 ml of fully demineralized water. The procedure was repeated until the wash water was neutral. The oil phase was then dried under reduced pressure at a maximum of 70° C.

This gave 272.6 g of a clear, reddish brown, oily liquid having an amine number of 57.2 mg KOH/g.

### Example 2

### Composition for Comparison

40 g of the material obtained in example 1 were transferred to a chromatography column (packed with 300 g of silica gel 60, particle size 0.063-0.2 mm as stationary phase, slurried with dichloromethane as mobile phase), using a small amount of dichloromethane as solvent. The eluate was separated into 12 fractions and analyzed by thin-layer chromatography (ready-coated TLC plates of silica gel 60, Merck, with dichloromethane as mobile phase). A substance with an RF of 0.95 was identified as the main component, and the corresponding fractions were combined and concentrated on a rotary evaporator at a bath temperature of 60° C. Residual dichloromethane was removed under reduced pressure, providing 9.1 g of a pale yellow liquid of low viscosity, having an amine number of 81.6 mg KOH/g. The compound obtained is identical to the specific benzoxazine monomer Bz described in the aforementioned publication by E. Calo et al.

### Bonding Tests

Adhesive bonding tests were carried out in a method based on ISO 4587. For this purpose, an overlapping bond with an area of 625 mm² was produced on raw steel test specimens with dimensions of 100×25×1 mm that had been degreased with acetone. The adhesive bonds were fixed using wooden clothes pins and were cured in a drying cabinet at 220° C. for 30 minutes. After they had cooled to room temperature, measurements were made of the tensile shear strength in accordance with ISO 4587. The results are shown in table 1:

TABLE 1
Adhesive bonding test results

| | | | Adhesive | | |
|---|---|---|---|---|---|
| Test | Curing | | bond layer | Tensile | |
| specimen | time | Curing | thickness | strength | Fracture |
| example # | (minutes) | temperature | [mm] | [MPa] | mode |
| Example 1 | 30 | 220° C. | 0.05 | 2.25 | cohesive |
| Example 1 | 30 | 220° C. | 0.1 | 1.94 | cohesive |
| Example 1 | 30 | 220° C. | 0.1 | 1.97 | cohesive |
| Example 1 | 30 | 220° C. | 0.1 | 2.07 | cohesive |
| Example 1 | 30 | 220° C. | 0.1 | 2.05 | cohesive |
| Example 2 | 30 | 220° C. | — | n.c.*) | — |
| Example 2 | 30 | 220° C. | — | n.c.*) | — |
| Example 2 | 30 | 220° C. | — | n.c.*) | — |
| Example 2 | 30 | 220° C. | — | n.c.*) | — |
| Example 2 | 30 | 220° C. | — | n.c.*) | — |

*) “n.c.” denotes “no curing” and should be understood as follows: The metal sheets could be parted from one another again by hand after cooling, and the bond area was sticky and liquid.

What is claimed is:

1. A method of bonding substrates comprising the steps of:
(a) providing an adhesive composition obtained by reacting a cardanol-containing cashew nut shell liquid (CNSL) with:
(i) ammonia, or an amine which comprises at least one primary or at least two secondary amino groups, and
(ii) formaldehyde;
(b) applying said adhesive composition to at least one of two or more substrates to be bonded, to form at least one coated substrate;
(c) joining together said coated substrate(s), optionally with an uncoated substrate, wherein said adhesive composition is located between the joined substrates; and
(d) curing.

2. The method of claim 1, wherein said cardanol-containing CNSL comprises crude CNSL.

3. The method of claim 1, wherein said cardanol-containing CNSL comprises purified CNSL.

4. The method of claim 3, wherein said purified CNSL is prepared by a method comprising the steps of pretreating and/or distilling.

5. The method of claim 4, wherein said pretreating comprises reaction with boric acid and/or acetic anhydride.

6. The method of claim 1, wherein component (i) comprises ammonia.

7. The method of claim 1, wherein component (i) comprises an amine which comprises at least one primary or at least two secondary amino groups.

8. The method of claim 7, wherein said amine is selected from the group consisting of polyamines comprising at least two primary and/or secondary amino groups.

9. The method of claim 1, wherein said substrates to be bonded are independently selected from the group consisting of metals, mineral materials, plastics, wood, glass and fibers.

10. The method of claim 1, wherein said curing step comprises thermal curing.
